(19) United States
(12) Patent Application Publication
(10) Pub. No.: US 2026/0131607 A1
(43) Pub. Date: May 14, 2026

(54) BUMPER ARRANGEMENT FOR A MOTOR VEHICLE

(71) Applicant: BENTELER AUTOMOBILTECHNIK GMBH, Paderborn (DE)

(72) Inventors: Andreas HITZ, Erwitte (DE); Konstantin TATARINOV, Bielefeld (DE); Martin SCHROETER, Paderborn (DE)

(21) Appl. No.: 19/380,965

(22) Filed: Nov. 6, 2025

(30) Foreign Application Priority Data
Nov. 14, 2024 (EP) 24212933.6

(51) Int. Cl. B60D 1/56

(52) U.S. Cl. CPC B60D 1/56

(57) ABSTRACT

The invention relates to a bumper arrangement for a motor vehicle, comprising a cross member extending in the transverse direction of the motor vehicle, wherein the cross member is designed as an open hollow profile in cross section, and a towing sleeve is arranged at least in sections within the hollow profile, wherein a reinforcement plate is arranged within the hollow profile and is connected to the cross member and the towing sleeve. The towing sleeve is connected to the cross member, wherein the reinforcement plate is oriented substantially perpendicular to the X-Y motor vehicle plane and obliquely to the longitudinal axis of the towing sleeve, wherein a section of the reinforcement plate is adapted to an outer contour of the towing sleeve and runs at least in sections along the outer contour.

### RELATED APPLICATIONS

The present application claims priority of European Application Number 24212933.6 filed Nov. 14, 2024, the disclosure of which is hereby incorporated by reference herein in its entirety.

### RELATED APPLICATIONS

The present disclosure relates to a bumper arrangement for a motor vehicle according to the features in the preamble of claim 1.

### BACKGROUND

A bumper arrangement is mounted on the front and rear of a motor vehicle. In some cases, the bumper arrangement has a cross-member extending in a transverse direction of the vehicle and is coupled to the rest of the chassis of the vehicle.

In order to be able to tow the motor vehicle, for example in the event of an accident or defect, towing sleeves are connected, for example joined, to the front and/or rear cross-member. In some cases, the towing sleeves have an internal thread for coupling to a towing eye, which in turn is able to be connected to a towing vehicle.

The joints between the towing sleeve and the cross-member are subject to high stresses during the towing process. When towing, the joints between the towing sleeve and the cross-member are subjected to stress, for example in the longitudinal direction of the vehicle.

In order to reduce corresponding loads, EP 2 054 246 B1 discloses coupling the towing sleeve to the cross-member via a reinforcement plate. The towing sleeve is joined to the reinforcement plate, and the reinforcement plate is then welded to the cross-member. In EP 2 054 246 B1, the reinforcement plate is aligned parallel to the longitudinal axis of the towing sleeve in order to reduce the loads occurring during the towing process.

In some cases, the towing sleeves and the associated towing eyes are also used to secure the motor vehicle, for example during transport of the motor vehicle by sea. For example, in some cases the motor vehicle is connected to the transport deck of the ship using tensioning straps via the towing eyes coupled to the towing sleeves. In contrast to typical load cases during towing, in this case a significant force in the vertical direction of the vehicle also acts on the towing sleeve, which places additional stress on the joints between the towing sleeve and the cross-member, and can lead to deformation of the cross-member. Since the motor vehicles are fixed to the transport deck for a longer period of time during sea transport, sufficient durability of the joints between the towing sleeve and the cross-member is desirable.

### SUMMARY

At least some embodiments provide a bumper arrangement for a motor vehicle. In at least some embodiments, the towing sleeve of the bumper arrangement is able to be loaded for example in the vertical direction of the motor vehicle.

The bumper arrangement according to at least some embodiments is usable for a motor vehicle and includes a cross-member extending in the transverse direction of the motor vehicle. The bumper arrangement is connected to the rest of the vehicle's chassis, for example at the front or the rear of the vehicle.

In at least some embodiments, the cross-member includes a portion that has an open hollow profile in cross-section. For example, in at least some embodiments, the cross-member has four sides, e.g., top, bottom, back, front, and one of these sides is open. The open hollow profile can also be called semi-open. The resulting opening is in at least some embodiments oriented in the longitudinal direction of the vehicle, pointing away from the vehicle. For example, in a bumper arrangement mounted on the front of the vehicle, the opening points forward in the direction of travel, which is the direction of forward travel, in at least some embodiments. In the case of a rear-mounted bumper arrangement, the opening points backwards in the direction of travel, which is the direction of reverse travel, in at least some embodiments.

In at least some embodiments, a towing sleeve is arranged at least in sections within the hollow profile, thus within the cross-member. At least in sections means, in the context of at least some embodiments, that at least part of the towing sleeve is arranged within the hollow profile or the cross-member. The towing sleeve is connected to the cross-member.

In at least some embodiments, a reinforcement plate is arranged within the hollow profile or cross-member, and is connected to the cross-member and the towing sleeve.

The bumper arrangement according to at least some embodiments has the reinforcement plate arranged substantially perpendicular to the motor vehicle plane that is spanned by the motor vehicle longitudinal direction and the motor vehicle transverse direction. The reinforcement plate is thus perpendicular to the plane spanned by the longitudinal and transverse directions of the vehicle, and is for example parallel to a direction extending from bottom to top of the vehicle.

In at least some embodiments, the reinforcement plate is also oriented at an angle to the longitudinal axis of the towing sleeve. Therefore, an angle is formed between the reinforcement plate and the longitudinal axis of the towing sleeve. In at least some embodiments, the longitudinal axis of the towing sleeve is aligned in the longitudinal direction of the vehicle, so that the reinforcement plate is also aligned obliquely to the longitudinal direction of the vehicle.

In at least some embodiments, a section of the reinforcement plate is adapted to an outer contour of the towing sleeve, and the section of the reinforcement plate runs at least in part along the outer contour of the towing sleeve. The section of the reinforcement plate is formed for example by an elongated semicircular indentation.

In at least some embodiments, the reinforcement plate is within the cross-member coupled with the towing sleeve, and thus the forces acting in the vertical direction of the vehicle when the motor vehicle is fixed via the towing sleeve are transferred from the towing sleeve to the reinforcement element, so that the connection points between the towing sleeve and the cross-member are relieved. Aligning the reinforcement plate perpendicular to the vehicle plane spanned by the vehicle longitudinal direction and the vehicle transverse direction, helps the forces acting in the vehicle vertical direction to be absorbed by the reinforcement plate. The oblique orientation of the reinforcement plate relative to the longitudinal axis of the towing sleeve enables a section of the reinforcement plate to be adapted to an outer contour, thus to an outer side of the towing sleeve, and to run at least in part along the outer contour of the towing sleeve. By accommodating the towing sleeve in this way, in the reinforcement plate the towing sleeve is additionally supported against a force acting in the vertical direction of the vehicle. The bumper arrangement according to at least some embodiments thus helps enable a secure fixation of the motor vehicle, for example for transport purposes, wherein the connections between the towing sleeve, the reinforcement plate and the cross-member can also withstand high loads in the vertical direction of the motor vehicle over longer periods of action and the towing sleeve can therefore also be loaded in the vertical direction of the motor vehicle.

The flexural rigidity of the cross-member is provided at least in part by the cross-section being U-shaped or C-shaped. In at least some embodiments, depending on the respective installation situation, a web oriented in the vertical direction of the vehicle is arranged at the rear of the cross-member. In at least some embodiments, opposite legs extend from the web, and are oriented in the longitudinal direction of the vehicle.

In at least some embodiments, the cross-member includes a hat-shaped cross-section. In the case that the cross-member includes the hat-shaped cross-section, the cross-member includes a web and two opposite legs extending from the web, with a corresponding flange being arranged at each free end of the legs, the flanges being oriented in the vertical direction of the motor vehicle.

In at least some embodiments, the cross-member includes a strike plate.

The angle formed between the longitudinal axis of the towing sleeve and the reinforcement plate is in at least some embodiments 5° to 40°, for example 10° to 30°. In at least some embodiments, corresponding angular intervals are used for connecting the reinforcement plate to the towing sleeve. For example, the reinforcement plate provides support for the towing sleeve in the corresponding angular intervals.

The reinforcement plate is connected for example to the web and the legs of the cross-member. In at least some embodiments, the reinforcement plate is joined, for example by welding, to the web and the legs of the cross-member. In at least some embodiments, the outer contour of the reinforcement plate is adapted to the shape defined by the web and the legs. In at least some embodiments, the reinforcement plate is completely connected to the cross-member along three longer sides. The corner regions are in at least some embodiments hollowed out.

In at least some embodiments, the reinforcement plate is joined to the towing sleeve, for example by welding. In at least some embodiments, the reinforcement plate is joined to the towing sleeve along the section adapted to the outer contour of the towing sleeve. This helps provide a secure fit between the towing sleeve and the reinforcement plate, so that the force is transmitted from the towing sleeve to the reinforcement plate. The welded connection is able to be made completely or partially along the section adapted to the outer contour of the towing sleeve.

In at least some embodiments, the towing sleeve is connected along a complete circumference of the towing sleeve, or at least in sections of the towing sleeve, to the cross-member and/or to a locking plate coupled to the cross-member. In at least some embodiments, the connection is a joint formed by welding.

In at least some embodiments, the reinforcement plate is formed from the material of the cross-member. For example, the reinforcement plate and the cross-member are both made of steel or an aluminum alloy in some embodiments. In other embodiments, the same material is not used for both the reinforcement plate and the cross-member, and the reinforcement plate and the cross-member have, for example, different ductilities. In at least some embodiments, forming the reinforcement plate and the cross-member from different materials allows the bumper arrangement to be thermally joined, for example by welding.

The reinforcement plate in at least some embodiments has a material thickness of 1.5 mm to 5 mm. In at least some embodiments, a material thickness of 1.5 mm to 5 mm provides a balance of the desired reinforcement effect and the weight and manufacturing costs of the reinforcement plate.

In at least some embodiments, the bumper arrangement includes two reinforcement plates, and the reinforcement plates are connected to the towing sleeve on opposite sides of the towing sleeve, which in at least some embodiments allows the force acting on the towing sleeve in the vertical direction as well as in the longitudinal direction of the vehicle to be absorbed by the reinforcement plates.

In at least some embodiments, two reinforcement plates are the same length and are oriented at the same angle relative to the longitudinal axis of the towing sleeve. In other embodiments, the reinforcement elements have different lengths and are aligned at different angles to the longitudinal axis of the towing sleeve. In at least some embodiments, the lengths are adapted depending on the application. In at least some embodiments, the formation of two reinforcement plates of equal length with identical angles to the towing sleeve helps enable an even distribution of the forces acting on the towing sleeve between the two reinforcement plates.

In at least some embodiments, the two reinforcement plates are able to be connected to each other at the ends of the reinforcement plates that face the opening of the cross-member. In at least some embodiments the connection is a joint formed by welding. In at least some embodiments, the two reinforcement plates are V-shaped when viewed from the vehicle plane spanned by the transverse and longitudinal directions of the vehicle, which enables the reinforcement plates to support each other and helps distribute forces.

In at least some embodiments, rather than connecting two separate reinforcement elements at the tip, a single reinforcement plate is provided with a V-shape when viewed from the vehicle plane spanned by the transverse direction and the longitudinal direction of the vehicle, wherein the tip of the reinforcement plate is oriented towards the opening of the cross-member and the reinforcement plate includes a recess in the region of the tip, and wherein the towing sleeve extends through the recess. The towing sleeve in at least some embodiments rests at least in part or completely on the contour of the recess such that the towing sleeve is supported by the recess in the reinforcement plate. In at least some embodiments, the towing sleeve is also joined to the reinforcement plate, for example in sections or completely, in the region of the recess, which helps provide a cost-effective way of supporting the towing sleeve, for example in the vertical direction of the vehicle.

In at least some embodiments, the bumper arrangement further comprises a crash box, wherein the crash box is connected to the cross-member on the side facing away from the opening. The reinforcement plate is in at least some embodiments arranged in the region of a wall of the crash box, and thus a force acting on the towing sleeve and the reinforcement plate can also be absorbed by the crash box. This further increases the strength of the bumper arrangement.

### BRIEF DESCRIPTION OF THE DRAWINGS

Further aspects of the present disclosure are set forth below and described in connection with the figures, in which:

FIG. 1 shows a bumper arrangement according to at least some embodiments in perspective view,

FIG. 2 shows the bumper arrangement as shown in FIG. 1 in a front view;

FIG. 3 shows the bumper arrangement of FIG. 1 in a side perspective,

FIG. 4 shows the bumper arrangement of FIG. 1 in a sectional view and in plan view,

FIGS. 5a-d show four bumper arrangements according to at least some embodiments, each in a detailed view in plan view and

FIG. 6 shows the bumper arrangement shown in FIG. 5d in a front view.

In the figures, the same reference numerals are used for same or corresponding components, although a repeated description may be omitted for reasons of simplicity.

### DETAILED DESCRIPTION

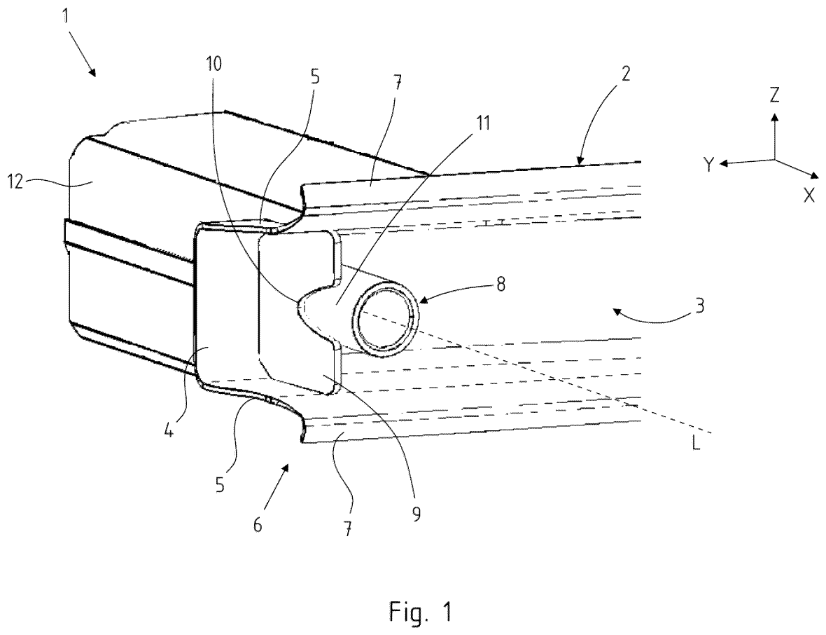

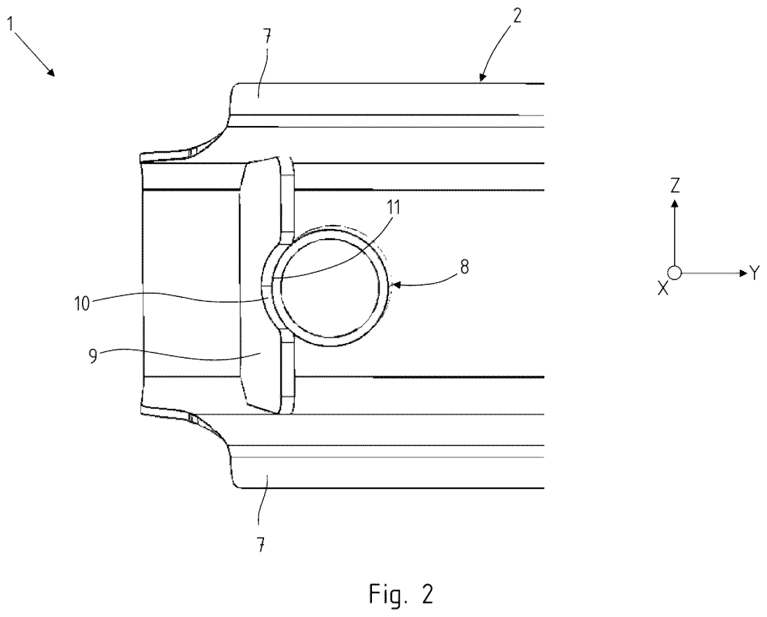

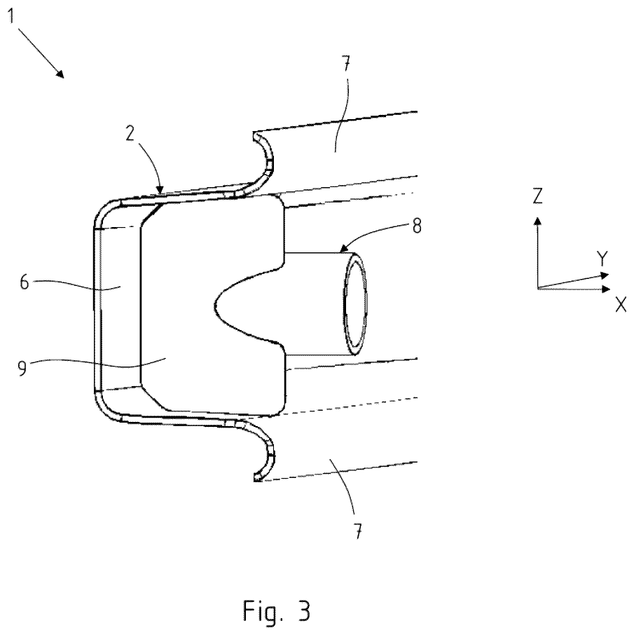

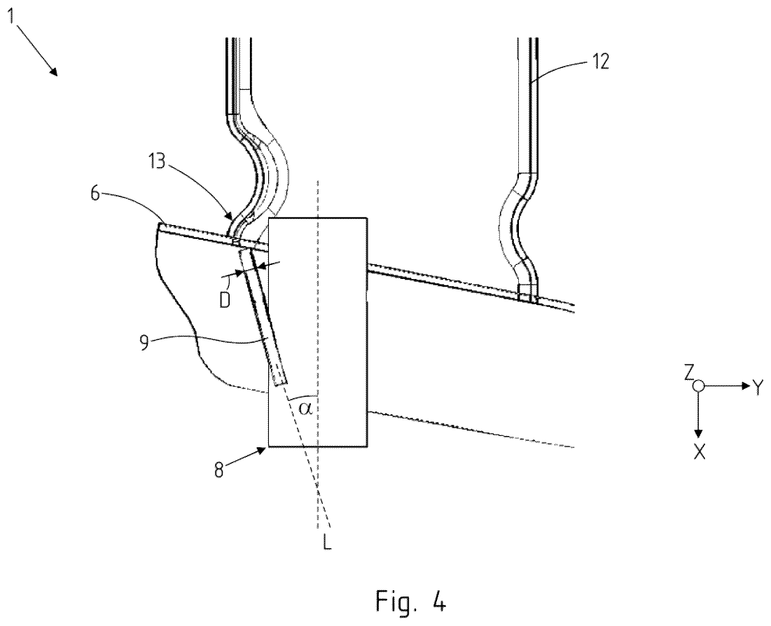

FIGS. 1 to 4 show a bumper arrangement 1 according to at least some embodiments for a motor vehicle. In FIGS. 1 and 4, the bumper arrangement 1 comprises a crash box 12, which is not shown in FIGS. 2 and 3 for reasons of clarity.

The bumper arrangement 1 shown in perspective in FIG. 1 includes a cross-member 2 extending in the transverse direction Y of the motor vehicle. The cross-member 2 includes a portion having, in cross-section, an open hollow profile, with the opening 3 of the hollow profile oriented in the longitudinal direction X of the vehicle, pointing away from the vehicle. The cross-member 2 is hat-shaped in cross-section, and includes a web 4 oriented in the vertical direction Z of the motor vehicle and two opposite legs 5 extending from the web 4. The legs 5 are oriented in the longitudinal direction X of the vehicle. At both free ends 6 of the legs 5, the cross-member 2 includes a corresponding flange 7 which is oriented in the vertical direction Z of the motor vehicle. The cross-section of the cross-member 2 is also shown for example in FIG. 3.

According to at least some embodiments, a towing sleeve 8 is arranged at least in sections within the hollow profile or the cross-member 2. A towing eye (not shown in detail) is able to be connected to the towing sleeve 8 so that the motor vehicle is able to be towed or secured via the towing sleeve 8. The towing sleeve 8 is welded to the cross-member 2 on its side facing the motor vehicle.

Furthermore, a reinforcement plate 9 is arranged within the hollow profile or cross-member 2 and is connected to the cross-member 2 and the towing sleeve 8 by welding. The reinforcement plate 9 is aligned perpendicular to the X-Y motor vehicle plane. The vertical alignment refers to the plane spanned by the two longer sides of the reinforcement plate 9 and not to the material thickness.

The reinforcement plate 9 is oriented obliquely to the longitudinal axis L of the towing sleeve 8 with respect to the plane spanned by the two longer sides of the reinforcement plate 9. This oblique arrangement can also be seen for example in the front view of the bumper arrangement 1 shown in FIG. 2.

In at least some embodiments, a section 10 of the reinforcement plate 9 is adapted to an outer contour 11 of the towing sleeve 8, and the section 10 runs at least in part along the outer contour 11 of the towing sleeve 8.

The section 10 is formed by an elongated semicircular indentation in the reinforcement plate 9. Due to the elongated semicircular indentation, the section 10 of the reinforcement plate 9, which is aligned obliquely to the towing sleeve 8, exactly follows the outer contour 11 of the towing sleeve 8. This is able to be seen for example in FIGS. 1 and 2.

In at least some embodiments, the reinforcement plate 9 is arranged within the cross-member 2 and the reinforcement plate 9 is coupled with the towing sleeve 8. Thus, the forces acting in the vertical direction of the vehicle when the motor vehicle is fixed via the towing sleeves 8 are transferred from the towing sleeve 8 to the reinforcement plate 9, so that the connection sections between the towing sleeve 8 and the cross-member 2 are relieved. The towing sleeve 8 is supported by the reinforcement plate 9 in the vertical direction Z of the vehicle. Deformation of the cross-member 2 itself can also be avoided in this way.

FIG. 4 shows a bumper arrangement 1 in a top view. An angle α of 20° is formed between the longitudinal axis L of the towing sleeve 8 and the reinforcement plate 9. A corresponding angle α enables the towing sleeve 8 to be supported by the reinforcement plate 9, since the towing sleeve 8 is at least partially received in the region 10 of the reinforcement plate 9 adapted to the outer contour 11 of the towing sleeve 8.

In at least some embodiments, the towing sleeve 8 and the reinforcement plate 9 are welded together along the region 10 of the reinforcement plate 9 that is adapted to the outer contour 11 of the towing sleeve 8.

In at least some embodiments, the reinforcement plate 9 has a material thickness D of 1.5 mm to 5 mm, which balances manufacturing costs, weight, and the reinforcement effectiveness.

In at least some embodiments, as shown by way of example in FIGS. 1 and 4, the bumper arrangement 1 includes a crash box 12. The crash box 12 is connected to the cross-member 2 on the side facing away from the opening 3. The reinforcement plate 9 is arranged at its end facing the crash box 12 in the region of a wall 13 of the crash box 12. This is shown for example in FIG. 4. The free end of the reinforcement plate 9 is directly opposite the wall 13 of the crash box 12, wherein the wall 13 of the crash box 12 and the reinforcement plate 9 are separated from each other by the web 6. Thus, a force acting on the towing sleeve 8 and the reinforcement plate 9 can also be transmitted to the crash box 12, which helps increase the strength of the bumper arrangement 1.

The towing sleeve 8 extends, in FIG. 4, through an opening within the web 6 of the cross-member 2 and is joined at this point along its entire circumference to the web 6 of the cross-member 2.

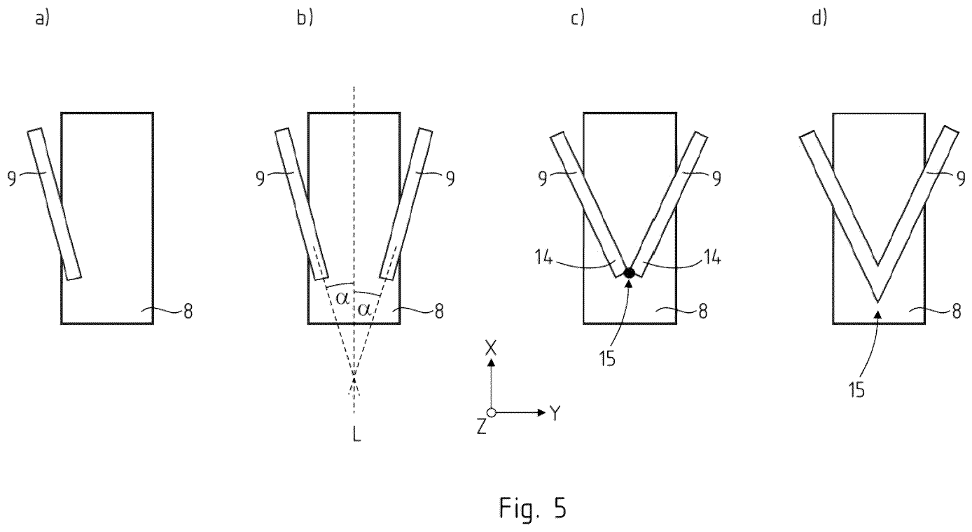

FIGS. 5a-d show four bumper arrangements that vary in how the reinforcement plate 9 and the towing sleeve 8 are aligned with each other within the bumper arrangement 1.

FIG. 5a shows an alignment between reinforcement plate 9 and towing sleeve 8, as can already be seen in FIGS. 1 to 4.

In the bumper arrangement shown in FIG. 5b, the bumper arrangement 1 includes two reinforcement plates 9. The reinforcement plates 9 are joined to the towing sleeve 8 on its opposite sides. The reinforcement plates 9 are thus aligned symmetrically to the towing sleeve 8 and have an identical length and shape. An angle α of 20° is formed between the two reinforcement plates 9 and the longitudinal axis L of the towing sleeve 8.

In the bumper arrangement shown in FIG. 5c, the bumper arrangement 1 also includes two reinforcement plates 9, wherein the reinforcement plates are arranged in a V-shape as viewed from the X-Y motor vehicle plane and are joined together at their free ends 14 to form the tip 15 of the V-shaped arrangement. The tip 15 of the joined reinforcement plates 9 is oriented towards the opening 3 of the cross-member 2.

In the bumper arrangement shown in FIG. 5d, the reinforcement plate 9 is V-shaped when viewed from the X-Y motor vehicle plane and the tip 15 of the reinforcement plate 9 is oriented towards the opening 3 of the cross-member 2.

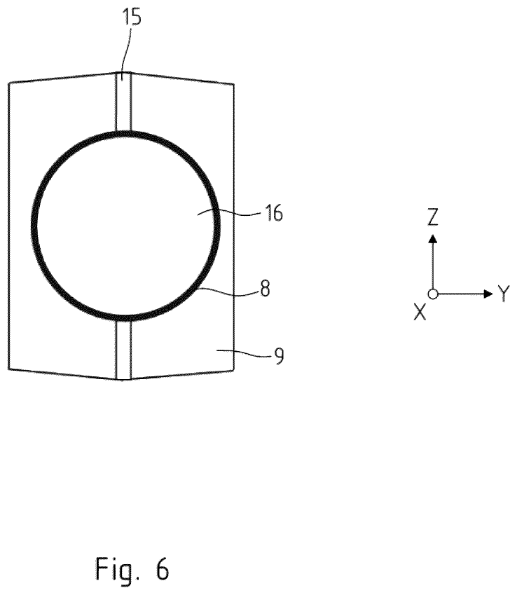

The bumper arrangement shown in FIG. 5d is shown in a front view in FIG. 6. The reinforcement plate 9 includes a recess 16 in the region of the tip 15, wherein the towing sleeve 8 extends through the recess 16 and is joined to the towing sleeve 8, for example along the entire circumference of the recess 16 or at least along parts of the recess 16. The bumper arrangement shown in FIG. 5d provides for support of the towing sleeve 8 by the reinforcement plate 9.

In at least some embodiments, both the reinforcement plate 9 and the cross-member 2 are made of steel or an aluminum alloy, which helps simplify the manufacture of the bumper arrangement and reduce manufacturing costs.

1. A bumper arrangement for a motor vehicle, the bumper arrangement comprising:
a cross-member extending in a transverse direction of the motor vehicle;
a towing sleeve; and
a reinforcement plate,
wherein:
the cross-member includes a portion having an open hollow profile in cross-section,
a towing sleeve is at least partially within the open hollow profile,
the reinforcement plate is within the open hollow profile and is connected to the cross-member and the towing sleeve,
the towing sleeve is connected to the cross-member,
the reinforcement plate is oriented substantially perpendicular to an X-Y plane of the motor vehicle and obliquely to a longitudinal axis of the towing sleeve, and
a section of the reinforcement plate is adapted to an outer contour of the towing sleeve and runs at least in part along the outer contour.

2. The bumper arrangement according to claim 1, wherein: the cross-member is C-shaped or U-shaped in cross-section, and has a web and two opposite legs extending from the web.

3. The bumper arrangement according to claim 1, wherein:
the cross-member is hat-shaped in cross-section, and has a web and two opposite legs extending from the web, and
the cross-member includes a respective flange that is located at a corresponding free end of each of the two legs, and the flanges are oriented in a vertical direction of the motor vehicle.

4. The bumper arrangement according to claim 1, wherein:
the longitudinal axis of the towing sleeve is at an angle of 5° to 40° relative to the reinforcement plate.

5. The bumper arrangement according to claim 2, wherein:
the reinforcement plate is connected to the web and the two legs of the cross-member.

6. The bumper arrangement according to claim 1, wherein:
the reinforcement plate is joined, to the towing sleeve.

7. The bumper arrangement according to claim 1, wherein:
the reinforcement plate and the cross-member are formed from a same material.

8. The bumper arrangement according to claim 1, wherein:
the open hollow profile has an opening that faces in a longitudinal direction of the motor vehicle and faces away from the motor vehicle.

9. The bumper arrangement according to claim 1, wherein:
the bumper arrangement includes two reinforcement plates, and
the reinforcement plates are connected to the towing sleeve on opposite sides of the towing sleeve.

10. The bumper arrangement according to claim 9, wherein:
the two reinforcement plates have a same length and are aligned at a same angle relative to the longitudinal axis of the towing sleeve.

11. The bumper arrangement according to claim 9, wherein:
ends of the reinforcement plates are connected to one another,
the open hollow profile has an opening that faces in a longitudinal direction of the motor vehicle and faces away from the motor vehicle, and
the connected ends of the reinforcement plates point towards the opening.

12. The bumper arrangement according to claim 1, wherein:
the reinforcement plate is V-shaped when viewed from the X-Y plane of the motor vehicle,
the open hollow profile has an opening that faces in a longitudinal direction of the motor vehicle and faces away from the motor vehicle,
a tip of the reinforcement plate is oriented towards the opening,
the reinforcement plate has a recess in a region of the tip,
the towing sleeve extends through the recess.

13. The bumper arrangement according to claim 1, wherein:
the bumper arrangement includes a crash box,
the open hollow profile has an opening that faces in a longitudinal direction of the motor vehicle and faces away from the motor vehicle,
the crash box is connected to the cross-member on a side of the cross-member that faces away from the opening, and
the reinforcement plate is arranged in a region of a wall of the crash box.

14. The bumper arrangement according to claim 1, wherein:
the towing sleeve is connected, at least in part to the cross-member.

15. The bumper arrangement according to claim 1, wherein:
the cross-member is coupled at least in part to a strike plate.

16. The bumper arrangement according to claim 1, wherein:
the longitudinal axis of the towing sleeve is at an angle of 10° to 30° relative to the reinforcement plate.

17. The bumper arrangement according to claim 2, wherein:
the reinforcement plate is welded to the web and the two legs of the cross-member.

18. The bumper arrangement according to claim 1, wherein:
the reinforcement plate is welded to the towing sleeve along an outer section of the reinforcement plate that is adapted to an outer contour of the towing sleeve.

19. The bumper arrangement according to claim 1, wherein:
the reinforcement plate and the cross-member are formed from a same steel or aluminum alloy material.

20. The bumper arrangement according to claim 9, wherein:
ends of the reinforcement plates are welded to one another,
the open hollow profile has an opening that faces in a longitudinal direction of the motor vehicle and faces away from the motor vehicle, and
the welded ends of the reinforcement plates point towards the opening.
